(19) United States
(12) Patent Application Publication
(10) Pub. No.: US 2006/0275906 A1
(43) Pub. Date: Dec. 7, 2006

(54) Method for ascertaining interferents in small liquid samples in an automated clinical analyzer

(76) Inventor: William Jackson Devlin SR., Lincoln University, PA (US)

Correspondence Address: DADE BEHRING INC.;LEGAL DEPARTMENT, 1717 DEERFIELD ROAD, DEERFIELD, IL, 60015, US

(21) Appl. No.: 11/144,999

(22) Filed: Jun. 3, 2005

(51) Int. Cl. G01N 35/00

(52) U.S. Cl. 436/43

(57) ABSTRACT

Accelerating the delivery of small samples for clinical analysis on an automated clinical analyzer by automatically inspecting for the presence of interferents like those that might be found within such samples after clinical analysis is commenced.

### FIELD OF THE INVENTION

The present invention relates to a method and apparatus for dispensing small liquid samples or other solutions potentially having analytical interferents therein into a container. In particular, the present invention provides a method for accelerating the delivery of small samples for analysis prior to inspecting for the presence of interferents like those that might be found within blood samples tested on an automated clinical analyzer.

### BACKGROUND OF THE INVENTION

Various types of analytical tests related to patient diagnosis and therapy can be performed by analysis of a liquid sample taken from a patient's infections, bodily fluids or abscesses. These assays are typically conducted with automated clinical analyzers onto which tubes or vials containing patient samples have been loaded. The analyzer extracts liquid sample from the vial and combines the sample with various reagents in special reaction cuvettes or tubes. Usually the sample-reagent solution is incubated or otherwise processed before being analyzed. Analytical measurements are often performed using a beam of interrogating radiation interacting with the sample-reagent combination, for example using photometric or fluorometric absorption readings or the like. The measurements allow determination of end-point or rate values from which an amount of analyte related to the health of the patient may be determined using well-known calibration techniques. Unfortunately, the quality of the liquid sample may adversely affect the accuracy of the results of the analyte measurement, in particular if colored interferents are present in the sample as a result of some preexisting sample condition.

For example, if an excess number of red blood cells are damaged, possibly during venipuncture or centrifugation or after prolonged storage, the sample is reddish in color and is said to exhibit “hemolysis.” The presence of free hemoglobin (Hb) may be used to measure the degree of hemolysis and when the hemoglobin concentration exceeds about 20 mg/dl, the hemoglobin may interfere in the calorimetric determination of analytes due to the reddish interferent in the sample.

Another interferent is an excess of bilirubin, the result of the heme of decaying red blood cells being converted in the spleen into bilirubin. Levels of bilirubin above 2-3 mg/dl are visibly yellowish and adversely affect enzyme-based immunoassays in particular. Such a condition is termed bilirubinaemia or icterus.

Another interferent is the whitish appearance in blood serum or plasma due to the presence of excess lipids. Such a condition is called lipemia and lipids levels above about 50 mg/dl may interfere with antibody binding in immunoassays.

A skilled technician will visually inspect the sample, and if judged to not have a normal light yellow to light amber color, the sample may be discarded. Otherwise, the sample will be tested as ordered. However, visual inspection is subjective, labor intensive and fraught with the possibility of human error. Thus, it is desirable to evaluate the integrity of a serum sample without visual inspection by a technician. One approach to this problem involves testing a portion of the sample using the analytical devices of the clinical analyzer prior to analyte assays being performed on the sample by the clinical analyzer. However, this procedure unnecessarily delays the availability of analyte concentration data. Another approach involves testing a portion of the sample simultaneously with performing assays on the sample both using analytical devices of the clinical analyzer. However, because of the trend toward smaller and smaller sample sizes (for patient considerations and to lower reagent costs), the analysis for interferents in a smaller sample portion may be less accurate.

Various methods have been implemented to ascertain whether hemolysis, icteris and lipemia (termed HIL) are present in a serum sample. U.S. Pat. No. 5,734,468 discloses monitoring a serum sample with a detector which performs a spectrophotometric analysis of the serum sample in the probe lumen through a substantially transparent section of the probe. From the spectrophotometric analysis, a hemolytic index, an icteric index and a lipemic index of the serum sample can be established. Based upon these serum indices, the serum sample can be transferred to a clinical analyzer for additional tests or can be disposed of because the sample is compromised.

U.S. Pat. No. 6,372,503 discloses quality control material disclosed is used to monitor instrument calibrations or used for recalibration for instruments which assess the amount of hemolysis, turbidity, bilirubinemia and biliverdinemia, either separately, or any two, or any three, or all four simultaneously, in plasma or serum samples.

U.S. Pat. No. 6,628,395 discloses preliminarily testing a sample for HIL in the original incoming sample container, prior to being removed from the container and prior to being transferred to a clinical analyzer. In this approach, sample is not consumed and can be transferred to the clinical analyzer or a waste receptacle, based upon results of the evaluation.

U.S. Pat. No. 6,353,471 discloses a method to reject a sample from further assay based on determining the concentration of at least one interferent in the sample by: (1) irradiating the sample with at least one frequency of radiation; (2) correlating absorbance of the radiation by the sample with a standard for the interferent(s) to determine the concentration of the interferent(s) and, (3) rejecting the sample if the concentration of the interferent(s) exceeds a predetermined criteria.

Another type of interferent adversely affect the overall quality of the aspiration process are abnormalities or non-uniformities within the sample. Non-uniformities such as clots, bubbles, foam, etc, are found in many samples, particularly when the sample is one of several body fluids as these frequently are of non-uniform composition. Various methods have been developed to detect the effect of such non-uniformities on the aspiration process.

U.S. Pat. No. 6,022,747 discloses a blood clot detector having a pressure transducer on an aspiration line to provide output voltage data to a microprocessor corresponding to the vacuum level during aspiration. The microprocessor integrates the vacuum readings over time during the aspiration cycle to provide a pressure integral for each test sample aspiration. Acceptability of the test sample for analysis is based upon a predetermined difference between a reference pressure integral and each test sample pressure integral.

U.S. Pat. Nos. 5,814,275, 5,622,869 and 5,451,373 relate to an apparatus for detecting obstructions of a flow line. A pressure detector detects changes in pressure within a flow cavity, indicating the presence of an obstruction.

U.S. Pat. No. 5,540,081 relates to a pipetting apparatus provided with clot detection comprising a nozzle for aspirating a sample. A plurality of pressure difference calculating circuits are connected with a pressure sensor, each for inputting an output of the pressure sensor and obtaining a pressure difference at a different pressure calculation period. A plurality of discriminating circuits each having a different discrimination threshold value determined according to each of the pressure calculation periods are provided.

U.S. Pat. No. 5,503,036 relates to an obstruction detection circuit for detecting an obstruction of a sample probe of an automated fluid sample aspiration/dispensation device and a method for detecting such an obstruction. In one embodiment, the obstruction detection circuit includes a pressure sensor measuring the pressure in a fluid conduit connecting a pump and to a sample probe orifice. The pressure within the connecting fluid conduit is measured shortly after the start of the aspiration or dispensation of a sample volume by the automated fluid sample aspiration-dispensation device. The pressure within the connecting fluid conduit is again measured after the completion of the aspiration or the dispensation by the pump, and if the pressure has not returned to a predetermined range within a predetermined amount of time, an error condition is reported.

U.S. Pat. No. 5,463,895 discloses provides an apparatus and method of detecting non-homogeneity in a fluid sample, by determining the ambient air pressure within a pipettor as a baseline reading, aspirating air into the pipettor as the pipettor moves towards a sample in container and monitoring for a pressure change in the pipettor to indicate the surface level of the fluid in said container.

Accordingly, from a study of the different approaches taken in the prior art to the problems encountered with endogenous interferents within small amounts of liquid samples to be tested, there is a need for a method to ascertain the presence of such interferents without adversely affecting the speed at which analytical test results are obtained and without making such a determination on a small sample portion which may adversely affect the accuracy of such a determination. There is a further need to ascertain the presence of sample non-uniformity interferents in a sample without encountering contamination risks associated with making non-uniformity measurement on a small sample portion.

### SUMMARY OF THE INVENTION

The principal object of the invention is to provide a method for analyzing samples within a biochemical analyzer without either delaying or affecting the accuracy of an analysis thereon. This is accomplished by dispensing small aliquot portions of an incoming sample into reaction cuvettes and immediately proceeding to conduct biochemical analyses thereon without testing for the presence of an interferent therein. Subsequent to this procedure, a larger remaining portion of the sample is tested for the presence of interferents like hemolysis, icteris and lipemia (HIL hereinafter) or liquid non-uniformities therein. By purposefully retaining the larger portion and conducting interferent tests thereon, the accuracy of the testing process is enhanced and the possibility of contamination of the small aliquot portions is eliminated. In addition, because the interferent testing is conducted after the biochemical analyses are begun, there are no delays in obtaining the desired analytical results. If the presence of an interferent is determined, such results may be provided with or separate from the biochemical analyses results obtained on the small aliquot portions of incoming samples. Optionally, if it is determined that no interferent is within the larger sample portion tested therefor, such results may be provided with or separate from the analytical results obtained on the small aliquot portions of incoming samples. An exemplary HIL analysis method measures sample absorption on the larger sample portion at three nanometer (nm) wavelengths from which HIL index values are calculated. The HIL test result comprises the “H”, “I”, and “L” index values as a 3-digit integer in which the first digit represents the “H” index, the second digit represents the “I” index, and the third digit represents the “L” index. The invention provides for biochemical analyses specific “Alert Indices”. Each biochemical analyte analyses may be provided with a specific “Alert Index” value that corresponds to “H”, “I”, and “L” Alert Values. An exemplary liquid non-uniformity analysis method comprises monitoring pressure within a pressure transducer during aspiration of the larger sample aliquot portion subsequent to dispensing small aliquot portions into reaction cuvettes and conducting biochemical analyses thereon.

### BRIEF DESCRIPTION OF THE DRAWINGS

The invention will be more fully understood from the following detailed description thereof taken in connection with the accompanying drawings which form a part of this application and in which:

FIG. 1 is a schematic plan view of an automated analyzer adapted to perform the present invention;

FIG. 2 is an enlarged schematic plan view of a portion of the analyzer of FIG. 1;

FIG. 2A is perspective view of a reaction cuvette useful in operating the analyzer of FIG. 1;

FIG. 3 is perspective view of an aliquot vessel array useful in the analyzer of FIG. 1;

FIG. 4 is a perspective view of an aliquot vessel array storage and handling unit useful in the analyzer of FIG. 1; and,

FIG. 5 is a schematic view of a liquid aspiration and dispensing system aspirating sample liquid from the aliquot vessel array of FIG. 3.

### DETAILED DESCRIPTION OF THE INVENTION

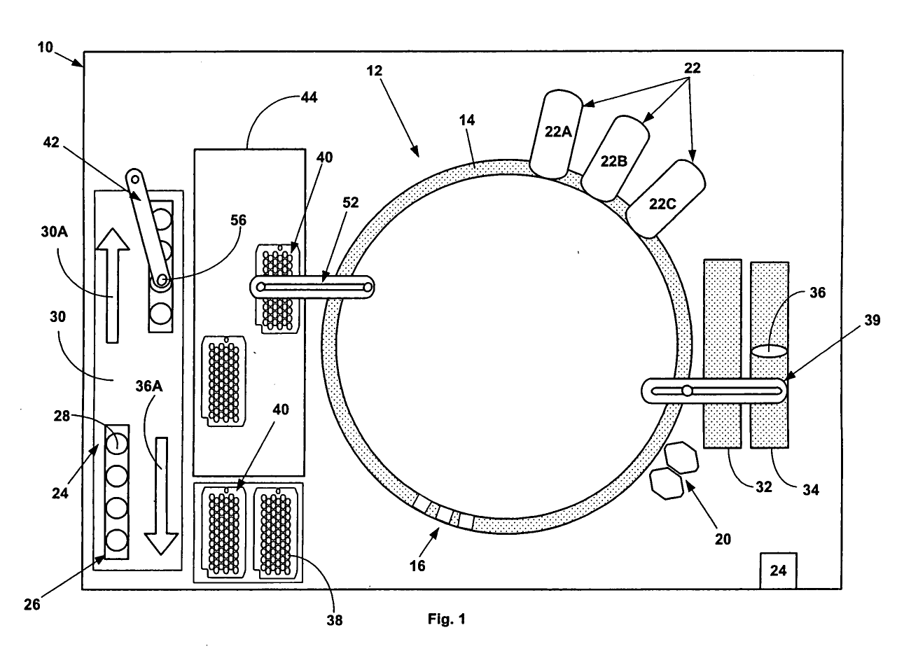

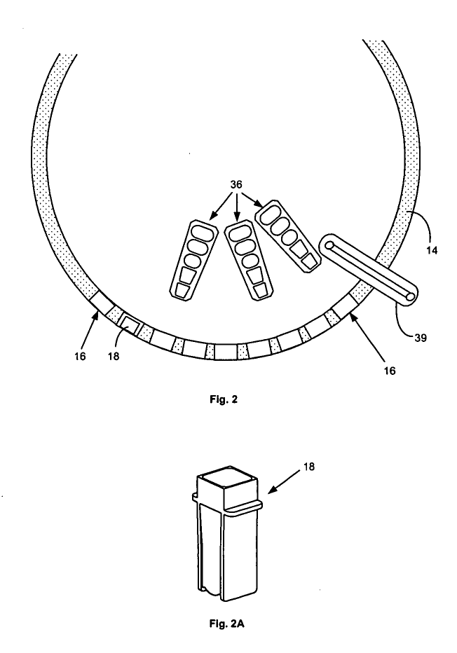

FIG. 1, taken with FIG. 2, shows schematically the elements of an automatic chemical analyzer 10 in which the present invention may be advantageously practiced, analyzer 10 comprising a reaction carousel 12 supporting an outer carousel ring 14 having cuvette ports 16. Cuvette ports 16 are adapted to receive a plurality of reaction cuvettes 18, like seen in FIG. 2A. Reaction carousel 12 is rotatable using stepwise movements in a constant direction, the stepwise movements being separated by a constant dwell time during which reaction carousel 12 is maintained stationary and computer controlled assay operational devices 20, such as sensors, reagent add stations, mixing stations and the like, operate as needed on an assay mixture contained within a cuvette 16. Analyzer 10 further includes a number of conventional assay detection devices 22 including a detection unit adapted to detect luminescence of a reaction mixture, and other, non-luminescence based detection units like a photometer 22A, a nephelometer 22B and an ion selective electrode 22C.

Analyzer 10 is controlled by software executed by the computer 24 based on computer programs written in a machine language like that used on the Dimension® clinical chemistry analyzer sold by Dade Behring Inc, of Deerfield, Ill., and widely used by those skilled in the art of computer-based electromechanical control programming. Computer 24 also executes application software programs for performing assays conducted by the assay detection devices 22.

As seen in FIG. 1, a bi-directional incoming and outgoing sample fluid tube transport system 24 comprises a mechanism for transporting sample fluid tube racks 26 containing open or closed sample fluid containers such as sample fluid tubes 28 from a rack input load position at a first end of an input lane 30 to the second end of input lane 30 as indicated by open arrow 30A. Liquid specimens contained in sample tubes 28 are identified by reading bar coded indicia placed thereon using a conventional bar code reader to determine, among other items, a patient's identity, tests to be performed, if a sample aliquot is to be retained within analyzer 10 and if so, for what period of time. It is also common practice to place bar coded indicia on sample tube racks 26 and employ a large number of bar code readers installed throughout analyzer 10 to ascertain, control and track the location of sample tubes 28 and sample tube racks 26.

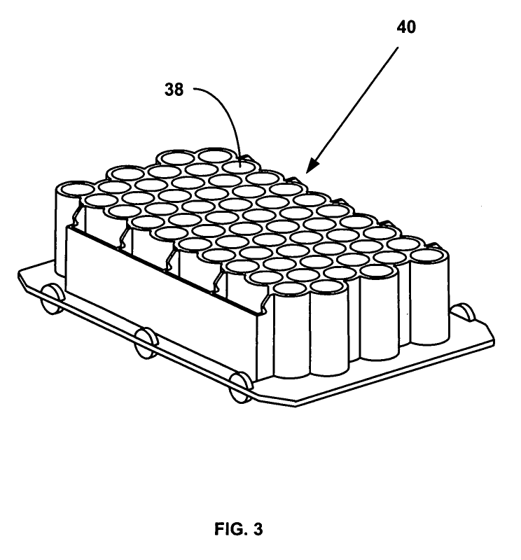

Temperature-controlled storage areas or servers 32 and 34 inventory a plurality of multi-compartment elongate reagent cartridges 36 containing reagents accessible by aspiration probe 39 as necessary to perform clinical assays on sample aliquots removed from sample tubes 28 and dispensed into aliquot wells 38 of an aliquot array 40 seen in FIG. 3.

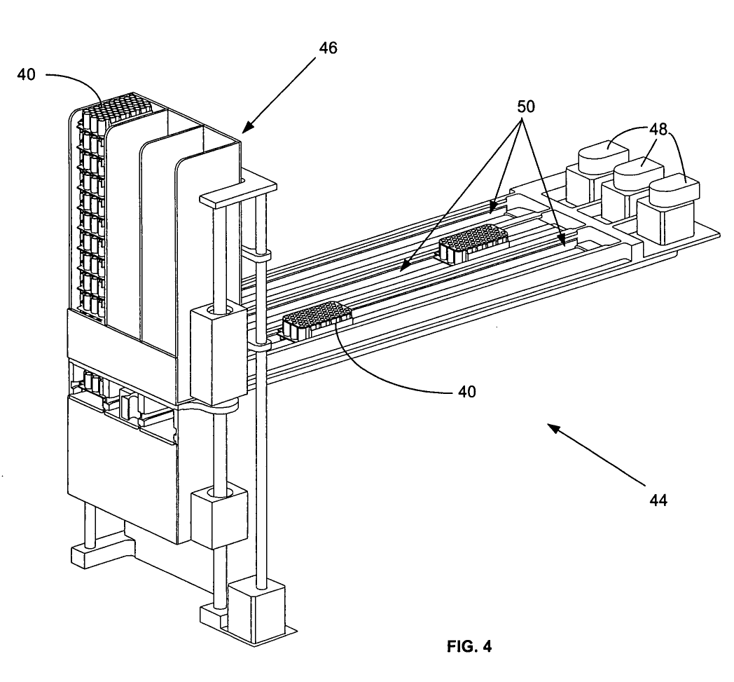

As mentioned earlier, an objective of the present invention is to provide a method for accelerating the delivery of small samples for analysis prior to inspecting for the presence of interferents like those that might be found within blood samples tested on an automated clinical analyze without delaying or otherwise affecting the integrity of an analysis thereon. To accomplish this objective, a conventional liquid sampling probe 42 is located proximate the second end of the input lane 30 and is operable to aspirate aliquot portions of sample fluid from sample fluid tubes 28 and to dispense an aliquot portion of the sample fluid into one or more of a plurality of aliquot wells 38 in aliquot vessel array 40. An aliquot vessel array transport system 44 seen in FIG. 4 comprises an aliquot vessel array storage and dispensing module 46 and a number of linear drive motors 48 adapted to bi-directionally translate aliquot vessel arrays 40 within a number of aliquot vessel array tracks 50 below a sample aspiration needle probe 52, located proximate reaction carousel 12. Sample aspiration probe 52 is controlled by computer 24 and is adapted to aspirate a controlled amount of sample from individual aliquot wells 34 positioned at a sampling location within a track 48 and is then shuttled to a dispensing location where an small aliquot amount of aspirated sample in the range of 1-2 uL is dispensed into one or more cuvettes 18 for analytical testing by analyzer 10 using conventional clinical assay methodology and assay detection devices 22.

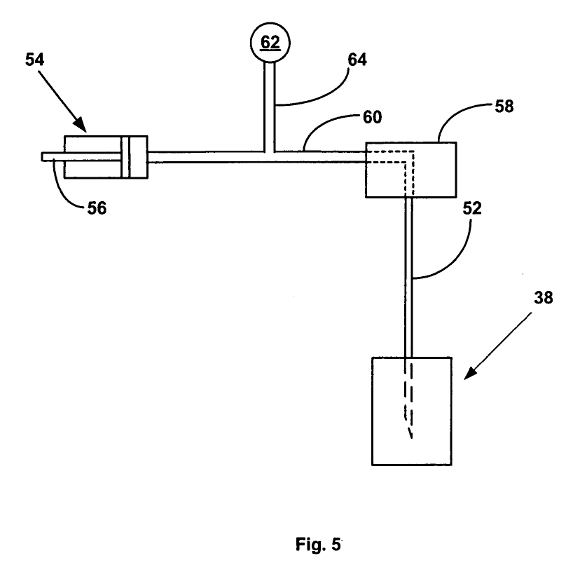

FIG. 5 shows a piston-type metering pump 54 comprising a computer-controlled piston 56 connected to a manifold 58 by a tube 60, manifold 54 supporting sample aspiration probe 52, tube 60 also connected to a conventional pressure measuring sensor 62 by another tube 64 installed between metering pump 54 and manifold 56. An exemplary pressure measuring sensor 62 is a pressure transducer (Model SCXL004DN from SenSym, Miltipas, Calif.) and is interfaced to the computer 28 to provide a measured air pressure within tubing 60. Metering pump 54 is carefully controlled by computer 24 to precisely aspirate and dispense smaller and larger sample aliquot portions. Pumping mechanisms other than a piston-type metering pump 54 may be employed to advantage in practicing the present invention as long as the pumping mechanism may be accurately controlled within the range of desired sample volumes. FIG. 5 also illustrates probe needle 52 having entered an aliquot vessel 38 and positioned within a sample liquid contained therein. Level sensing means, for example using well known capacitive signals, may be advantageously employed in order to ensure that probe needle 52 is in fluid communication with the sample liquid. Metering pump 54 is activated and the distance the piston 56 is moved is controlled by computer 24 so that an accurately known volume of sample liquid is aspirated or dispensed by probe needle 52 thereby forming smaller and larger sample aliquot portions. The mechanisms for accurately controlling metering pump 54 so that aspirated smaller and larger sample aliquot portions span the range of about 1 to 10 microliters (uL) include piston syringes driven by stepper motors (like those made by Cavro Co.) or a piston displacement in a sealed cavity where the piston is coupled to a stepper motor (like those made by Lee Co.).

Subsequent to the dispensing of sample into a cuvette 18, a larger aliquot portion of the sample in the range of about 10 uL is aspirated by aspiration probe 52 from individual aliquot wells 34 and is then dispensed into another cuvette 18 and tested for the presence of interferents like hemolysis, icteris and lipemia and for the presence of non-uniformity interferents like such as clots, bubbles, or foam. By purposefully retaining the larger aliquot portion and conducting interferent tests on the larger portion as opposed to conducting interferent tests on the smaller aliquot portion, the accuracy of the testing is enhanced and the possibility of contamination of the small aliquot portions is eliminated. In addition, because the interferent testing is conducted after the analytical tests are begun, there are no delays in obtaining the desired analytical results. In addition, during aspiration of the larger aliquot portion, the pressure in aspiration

In an exemplary method, the larger aliquot portion is tested for the presence of interferents like hemolysis, icteris and lipemia using photometer 22A wherein the ‘H’ absorbance is derived from blanked, bichromatic measurements at 405 and 700 nm, and the ‘I’ absorbance is derived from blanked, bichromatic measurements at 452 and 700 nm and the ‘L’ absorbance is derived from a blanked 700 nm measurement. Conversion from the absorbance measurements to HIL concentration is computed based on predetermined calibration correlations for all three interferences. The aforementioned HIL indices are associated with the concentration in mg/dL for each of the interferences as specified in Table 1.

TABLE 1

| | ‘Hemoylsis’ | ‘Icteris’ | ‘Lipemia’ |
|---|---|---|---|
| | Hemoglobin | Bilirubin | Lipids |
| Index | mg/dL | mg/dL | mg/dL |
| 1 | H ≦ 10 | I ≦ 2 | L ≦ 50 |
| 2 | 10 < H ≦ 25 | 2 < I ≦ 5 | 50 < L ≦ 100 |
| 3 | 25 < H ≦ 50 | 5 < I ≦ 10 | 100 < L ≦ 200 |
| 4 | 50 < H ≦ 200 | 10 < I ≦ 15 | 200 < L ≦ 400 |
| 5 | 200 < H ≦ 300 | 15 < I ≦ 20 | 400 < L ≦ 600 |
| 6 | 300 < H ≦ 500 | 20 < I ≦ 40 | 600 < L ≦ 800 |
| 7 | 500 < H ≦ 1,000 | 40 < I ≦ 60 | 800 < L ≦ 1,000 |
| 8 | H > 1,000 | I > 60 | L > 1,000 |

An index of 1 represents concentrations of the interferences not normally affecting the analytical feature results. The HIL result, termed the “Sample Index” comprises the ‘H’, ‘I’, and ‘L’ index values as a 3-digit integer XYZ in which the first digit X represents the ‘H’ index, the second digit Y represents the ‘I’ index, and the last digit Y represents the ‘L’ index.

In use, computer 24 will typically be programmed with biochemical assay-specific “Alert Index”. Those assays that exhibit HIL susceptibility will have an Alert Index value that corresponds to ‘H’, ‘I’, and ‘L’ alert values. Alert Indexes can be edited by a user to customize whether a specific method requires HIL checking of the sample, i.e., whether the system will run an HIL along with the associated method, or the minimum HIL index values at which HIL interferences are flagged for a specific method. For example, an assay for glucose might be pre-assigned an HIL Alert Index of “333” and the HIL interferents might be measured as having concentrations of 100, 7 and 500 mg/dl, respectively, using photometer 22A so that the Sample Index is determined from Table 1 as “435”. In this case, the HIL results will be reported as above normal on separate line on an assay report by computer 24 along with all other clinical assay results on the sample. In contrast, HIL might be measured as having concentrations of 20, 3 and 25 mg/dl, respectively, using photometer 22A so that the Sample Index is determined from Table 1 as “221” and the HIL results will be reported as within a normal range. In either case, however, and in accord with the present invention, interferent testing is conducted after the analytical testing so there are no delays in obtaining the desired analytical results.

In another exemplary method of the present invention, the larger aliquot portion is tested for the presence of non-uniformity interferents like such as clots, bubbles, or foam using pressure measuring sensor 62. This method comprises (1) determining a baseline air pressure within tube 60 prior to aspiration of air into probe 52; (2) operating piston 56 to aspirate air into probe 52 as probe 52 is lowered into sample contained in well 38; and, (3) monitoring pressure within tube 60 using pressure measuring sensor 62 during aspiration of the larger sample aliquot portion; and, (4) recording whether or not the monitored pressure remained within a range of values predetermined for samples without the presence of non-uniformity interferents like such as clots, bubbles, or foam. The presence of clots will clog probe 52 causing the monitored pressure to sharply increase while the presence of bubbles or foam will cause the monitored pressure to sharply decrease. The result may be reported as a “Yes/No” non-uniformity interferent result along with analytical results obtained by analyzer 10 on the previously aspirated and analyzed smaller sample aliquot portions. In either case, however, and in accord with the present invention, non-uniformity interferent testing is conducted after the analytical testing so there are no delays in obtaining the desired analytical results and so that the accuracy of non-uniformity interferent evaluation is increased.

It should be readily appreciated by those persons skilled in the art that the present invention is susceptible of broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

We claim:

1. A method for determining the presence of interferents within clinical analysis samples on an automated clinical analyzer by:
aspirating a first aliquot portion of sample to be analyzed at a first moment in time;
initiating the clinical analysis scheduled to be performed;
aspirating a second aliquot portion of sample to be analyzed at a second moment in time, wherein said second moment in time is subsequent to said first moment in time;
initiating a measurement for the presence of interferents within said second aliquot portion of sample after clinical analysis is commenced; and,
reporting the presence of interferents within said second aliquot portion of sample.

2. The method of claim 1 wherein the interferents are one or more of hemolysis, icteris and lipemia.

3. The method of claim 1 wherein the interferents are one or more of clots, bubbles or foam.

4. The method of claim 1 wherein first aliquot portion of sample to be analyzed is a smaller portion in the range of about 1-2 uL and the second aliquot portion of sample is a larger portion in the range of about 10 uL.

5. The method of claim 2 wherein the measured presence of hemolysis, icteris and lipemia are converted into indexes that increase incrementally as the level of hemolysis, icteris and lipemia increase and represent the ‘H’ index, the ‘I’ index, and the ‘L’ index, respectively.

6. The method of claim 5 further comprising recording the measured presence of interferents as a 3-digit integer Sample Index in which the first digit represents the ‘H’ index, the second digit represents the ‘I’ index, and the last digit represents the ‘L’ index.

7. The method of claim 6 further comprising assigning a 3-digit as an Alert Index integer to the clinical analysis scheduled to be performed and comparing said Alert Index to said Sample Index.

8. The method of claim 7 further comprising reporting the comparison of Alert Index to said Sample Index as part of reporting the results of the clinical analysis scheduled to be performed.

9. The method of claim 3 further comprising recording the measured presence of interferents as a 3-digit integer Sample Index in which the first digit represents the ‘H’ index, the second digit represents the ‘I’ index, and the last digit represents the ‘L’ index.

10. The method of claim 3 wherein the measured presence of clots, bubbles or foam comprises measuring air pressure during aspiration of the larger sample aliquot portion and determining whether or not the monitored pressure remained within a range of values predetermined for samples without the presence of clots, bubbles, or foam.

11. The method of claim 10 further comprising whether or not the monitored pressure remained within the predetermined range as part of reporting the results of the clinical analysis scheduled to be performed.

12. A device for determining the presence of interferents within clinical samples scheduled to be analyzed on an automated clinical analyzer, the device comprising:
a probe adapted for aspirating a first aliquot portion of sample to be analyzed at a first moment in time;
a computer within said analyzer programmed to initiate the clinical analysis scheduled to be performed on said first aliquot portion of sample;
the probe also adapted for aspirating a second aliquot portion of sample to be analyzed at a second moment in time, wherein the second moment in time is subsequent to said first moment in time;
the computer also programmed to initiate measurements after said second moment in time for the presence of interferents within said second aliquot portion of sample, and to report the presence of interferents within said second aliquot portion of sample.

13. The device of claim 1 wherein the interferents are one or more of hemolysis, icteris and lipemia.

14. The device of claim 1 wherein the interferents are one or more of clots, bubbles or foam.

15. The device of claim 1 wherein first aliquot portion of sample to be analyzed is a smaller portion in the range of about 1-2 uL and the second aliquot portion of sample is a larger portion in the range of about 10 uL.
